(19) United States
(12) Patent Application Publication
(10) Pub. No.: US 2015/0286859 A1
(43) Pub. Date: Oct. 8, 2015

(54) Image Processor Comprising Gesture Recognition System with Object Tracking Based on Calculated Features of Contours for Two or More Objects

(71) Applicant: Avago Technologies General IP (Singapore) Pte.Ltd., Singapore (SG)

(72) Inventors: Denis Vladimirovich Zaytsev, Dzerzhinsky (RU); Denis Vasilyevich Parfenov, Moscow (RU); Pavel Aleksandrovich Aliseitchik, Moscow (RU); Denis Vladimirovich Parkhomenko, Mytyschy (RU); Alexander Borisovich Kholodenko, Moscow (RU)

(21) Appl. No.: 14/675,260

(22) Filed: Mar. 31, 2015

(30) Foreign Application Priority Data
Apr. 3, 2014 (RU) 2014113049

(51) Int. Cl. G06K 9/00; G06K 9/46

(52) U.S. Cl. CPC G06K 9/00335; G06K 9/4604

(57) ABSTRACT

An image processing system comprises an image processor having image processing circuitry and an associated memory. The image processor is configured to implement an object tracking module. The object tracking module is configured to obtain one or more images, to extract contours of at least two objects in at least one of the images, to select respective subsets of points of the contours for the at least two objects based at least in part on curvatures of the respective contours, to calculate features of the subsets of points of the contours for the at least two objects, to detect intersection of the at least two objects in a given image, and to track the at least two objects in the given image based at least in part on the calculated features responsive to detecting intersection of the at least two objects in the given image.

### FIELD

The field relates generally to image processing, and more particularly to image processing for object tracking.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement an object tracking module. The object tracking module is configured to obtain one or more images, to extract contours of at least two objects in at least one of the images, to select respective subsets of points of the contours for the at least two objects based at least in part on curvatures of the respective contours, to calculate features of the subsets of points of the contours for the at least two objects, to detect intersection of the at least two objects in a given image, and to track the at least two objects in the given image based at least in part on the calculated features responsive to detecting intersection of the at least two objects in the given image.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing an object tracking module in an illustrative embodiment.

FIG. 2 is a flow diagram of an exemplary object tracking process performed by the object tracking module in the image processor of FIG. 1.

FIG. 3 illustrates calculation of convexity signs for a contour.

FIG. 4 illustrates an example of gestures performed for a map application.

FIG. 5 is an image of two separate hand poses.

FIG. 6 is an image showing intersection of the hand poses shown in FIG. 5.

FIG. 7 is another image showing intersection of the hand poses shown in FIG. 5.

FIG. 8 is an image of two separate hand poses.

FIG. 9 is an image showing intersection of the hand poses shown in FIG. 8.

FIG. 10 is another image showing intersection of the hand poses shown in FIG. 8.

FIG. 11 is another image showing intersection of the hand poses shown in FIG. 8.

FIG. 12 illustrates a taut string approach for contour regularization.

FIG. 13 illustrates contour regularization using taut string with polar coordinate unwrapping.

FIG. 14 illustrates contour parameterization before and after application of the contour regularization in FIG. 13.

FIG. 15 illustrates contour regularization using taut string and independent coordinate processing.

FIG. 16 illustrates contour coordinates before and after application of the contour regularization in FIG. 15.

FIG. 17 illustrates point coordinate prediction.

FIG. 18 illustrates decomposition functions for point coordinate prediction.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves object tracking in one or more images.

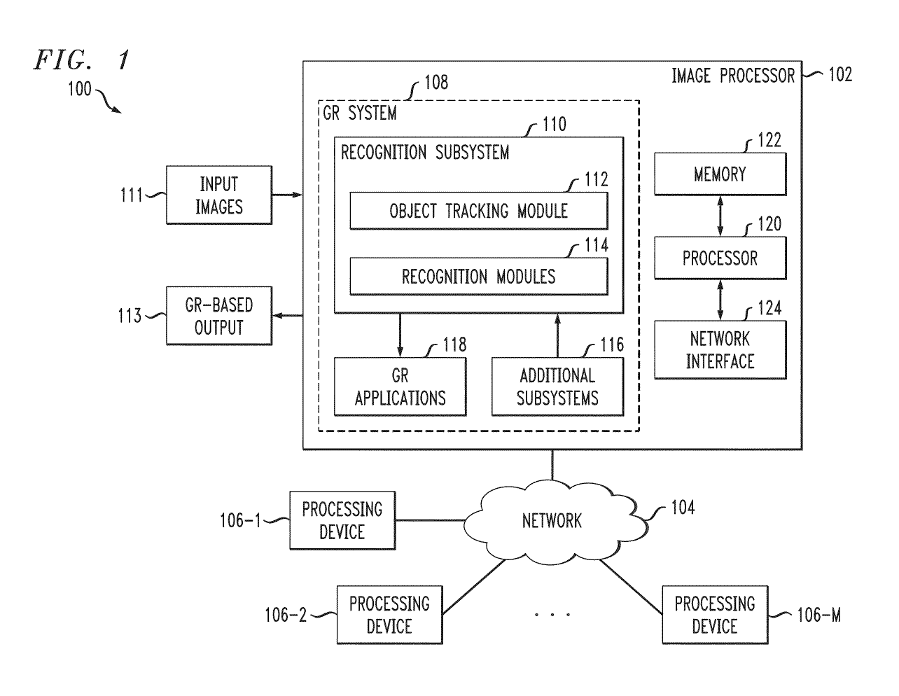

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 110 within a gesture recognition (GR) system 108. The GR system 108 in this embodiment processes input images 111 from one or more image sources and provides corresponding GR-based output 113. The GR-based output 113 may be supplied to one or more of the processing devices 106 or to other system components not specifically illustrated in this diagram.

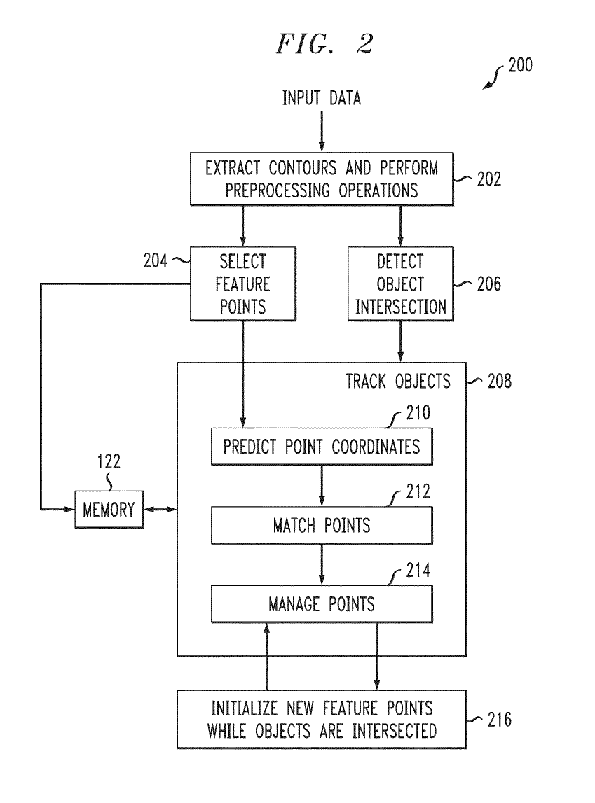

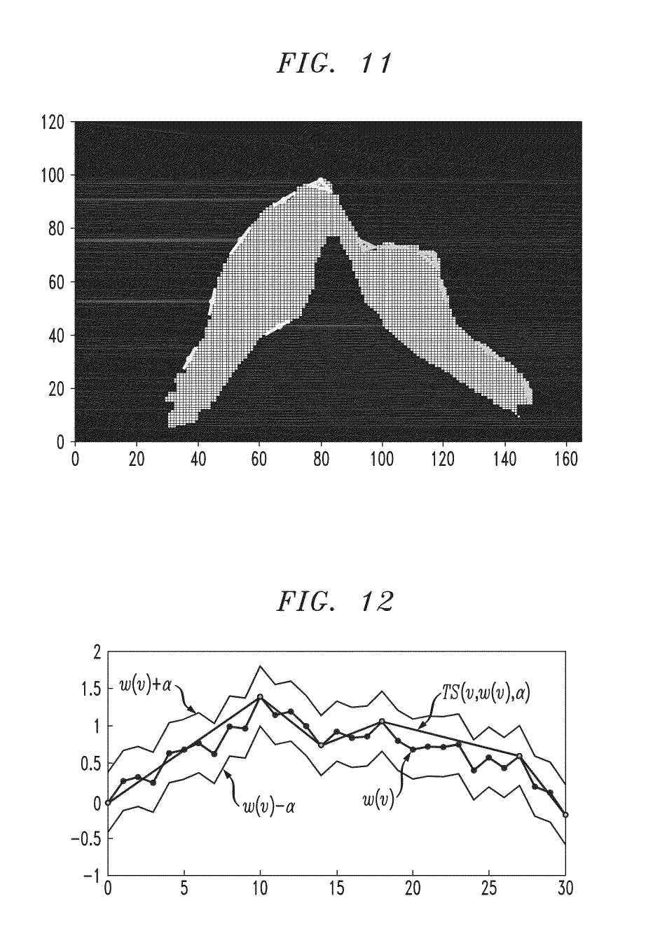

The recognition subsystem 110 of GR system 108 more particularly comprises an object tracking module 112 and recognition modules 114. The recognition modules 114 may comprise, for example, respective recognition modules configured to recognize static gestures, cursor gestures, dynamic gestures, etc. The object tracking module 112 is configured to track one or more objects in a series of images or frames. The operation of illustrative embodiments of the GR system 108 of image processor 102 will be described in greater detail below in conjunction with FIGS. 2 through 18.

The recognition subsystem 110 receives inputs from additional subsystems 116, which may comprise one or more image processing subsystems configured to implement functional blocks associated with gesture recognition in the GR system 108, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 108 are described in PCT International Application PCTUS201356937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 108 are described in PCT International Application PCTUS2014031562, filed on Mar. 24, 2014 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 110 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 110 recognizes within the image a gesture from a specified gesture or pose vocabulary and generates a corresponding gesture pattern identifier (ID) and possibly additional related parameters for delivery to one or more of the GR applications 118. The configuration of such information is adapted in accordance with the specific needs of the application.

Additionally or alternatively, the GR system 108 may provide GR events or other information, possibly generated by one or more of the GR applications 118, as GR-based output 113. Such output may be provided to one or more of the processing devices 106. In other embodiments, at least a portion of set of GR applications 118 is implemented at least in part on one or more of the processing devices 106.

Portions of the GR system 108 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 108.

Although some embodiments are described herein with reference to recognition of static of dynamic hand gestures, it should be noted that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the GR applications 118 may be implemented on a different processing device than the subsystems 110 and 116, such as one of the processing devices 106.

Moreover, it is to be appreciated that the image processor 102 may itself comprise multiple distinct processing devices, such that different portions of the GR system 108 are implemented using two or more processing devices. The term “image processor” as used herein is intended to be broadly construed so as to encompass these and other arrangements.

The GR system 108 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 108 from the depth sensor may include a stream of frames comprising respective depth images, with each such depth image comprising a plurality of depth image pixels. For example, a given depth image D may be provided to the GR system 108 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 113 to one or more image destinations. At least a subset of such image sources and image destinations may be implemented at least in part utilizing one or more of the processing devices 106.

Accordingly, at least a subset of the input images 111 may be provided to the image processor 102 over network 104 for processing from one or more of the processing devices 106. Similarly, processed images or other related GR-based output 113 may be delivered by the image processor 102 over network 104 to one or more of the processing devices 106. Such processing devices may therefore be viewed as examples of image sources or image destinations as those terms are used herein.

A given image source may comprise, for example, a 3D imager may including an infrared Charge-Coupled Device (CCD) sensor and a depth camera such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 112, 114, 116 and 118 of image processor 102. One possible example of image processing circuitry that may be used in one or more embodiments of the invention is an otherwise conventional graphics processor suitably reconfigured to perform functionality associated with one or more of the components 112, 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 113 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 110 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

In some embodiments objects are represented by blobs, which provides advantages relative to pure mask-based approaches. In mask-based approaches, a mask is a set of adjacent points that share a same connectivity and belong to the same object. In relatively simple scenes, masks may be sufficient for proper object recognition. Mask-based approaches, however, may not be sufficient for proper object recognition in more complex and true-to-life scenes. The blob-based approach used in some embodiments allows for proper object recognition in such complex scenes. The term “blob” as used herein refers to an isolated region of an image where some properties are constant or vary within some defined threshold relative to neighboring points having different properties. Examples of such properties include color, hue, brightness, distances, etc. Each blob may be a connected region of pixels within an image.

The use of blobs allows for representation of scenes with an arbitrary number of arbitrarily spatially situated objects. Each blob may represent a separate object, an intersection or overlapping of multiple objects from a camera viewpoint, or a part of a single solid object visually split into several parts. This latter case happens if a part of the object has sufficiently different reflective properties or is obscured with another body. For example, a finger ring optically splits a finger into two parts. As another example, a bracelet cuts a wrist into two visually separated blobs.

Some embodiments use blob contour extraction and processing techniques, which can provide advantages relative to other embodiments which utilize binary or integer-valued masks for blob representation. Binary or integer-valued masks may utilize large amounts of memory. Blob contour extraction and processing allows for blob representation using significantly smaller amounts of memory relative to blob representation using binary or integer-valued masks. Whereas blob representation using binary or integer-valued masks typically uses matrices of all points in the mask, contour-based object description may be achieved with vectors providing coordinates of blob contour points. In some embodiments, such vectors may be supplemented with additional points for improved reliability.

Embodiments may use a variety of contour extraction methods. Examples of such contour extraction methods include Canny, Sobel and Laplacian of Gaussian methods.

Raw images which are retrieved from a camera may contain a considerable amount of noise. Sources of such noise include poor, uniform and unstable lighting conditions, object motion and jitter, photo receiver and preliminary amplifier internal noise, photonic effects, etc. Additionally, ToF or SL 3D image acquisition devices are subject to distance measurement and computation errors.

The presence of additive and multiplicative noise in some embodiments leads to low-quality images and depth maps. Additive noise usually has a Gaussian distribution. An example of multiplicative noise is Poisson noise. As a result of additive and/or multiplicative noise, contour extraction can result in rough, ragged blob contours. In addition, some contour extraction methods apply differential operators to input images, which are very sensitive to additive and multiplicative function variation and may amplify noise effects. Such noise effects are partially reduced via application of noise reduction techniques. Various other preprocessing techniques including contour regularization techniques involving relatively low computation costs are used in some embodiments for contour improvement.

As discussed above, blobs may be used to represent a whole scene having an arbitrary number of arbitrarily spatially situated objects. Different blobs within a scene may be assigned numerical measures of importance based on a variety of factors. Examples of such factors include but are not limited to the relative size of a blob, the position of a blob with respect to defined regions of interest, the proximity of a blob with respect to other blobs in the scene, etc.

In some embodiments, blobs are represented by respective closed contours. In these embodiments, contour de-noising, shape correction and other preprocessing tasks may be applied to each closed contour blob independently, which simplifies subsequent processing and permits easy parallelization.

Various embodiments will be described below with respect to contours described using vectors of x, y coordinates of a Cartesian coordinate system. It is important to note, however, that various other coordinate systems may be used to define blob contours. In addition, in some embodiments vectors of contour points also include coordinates along a z-axis in the Cartesian coordinate system. An xy-plane in the Cartesian coordinate system represents a 2D plane of a source image, where the z-axis provides depth information for the xy-plane.

Contour extraction procedures may provide ordered or unordered lists of points. For ordered lists of contour points, adjacent entries in a vector describing the contour represent spatially adjacent contour points with a last entry identifying coordinates of a point preceding the first entry as contours are considered to be closed. For unordered lists of points, the entries are spatially unsorted. Unordered lists of points may in some cases lead to less efficient implementations of various pre-processing tasks.

In some embodiments, the object tracking module 112 tracks the position of two hands or other objects when the hands or other objects are intersected in a series of frames or images. As objects in a scene move from frame to frame, setting inter-frame feature point correspondence becomes more difficult, especially in situations in which motion is fast and/or the frame rate is not high enough to ensure complete or nearly complete inter-frame correlation. Some embodiments use feature point trajectory and prediction to overcome these issues. For example, based on known noisy point coordinate measurements for a series of frames, some embodiments produce stable point position estimates for future frames. In addition, some embodiments improve the accuracy of known noisy feature points in previous frames.

The operation of the GR system 108 of image processor 102 will now be described in greater detail with reference to the diagrams of FIGS. 2 through 18.

FIG. 2 shows a process 200 which may be implemented at least in part using the object tracking module 112 in the image processor 102. The process 200 begins with block 202, extracting contours and performing preprocessing operations on input data. The input data is an example of the input images 111, and may include a series of frames which include data on distances, amplitudes, validity masks, colors, etc. The frame data may be captured by a variety of different imager types such as depth, infrared or Red-Green-Blue (RGB) imagers. The frame data may also be provided or obtained from a variety of other image sources.

Contour extraction in block 202 provides contours of one or more blobs visible in a given frame. Examples of preprocessing operations which are performed in some embodiments include application of one or more filters to depth and amplitude data of the frames. Examples of such filters include low-pass linear filters to remove high frequency noise, high-pass linear filters for noise analysis, edge detection and motion tracking, bilateral filters for edge-preserving and noise-reducing smoothing, morphological filters such as dilate, erode, open and close, median filters to remove “salt and pepper” noise, and de-quantization filters to remove quantization artifacts.

In some embodiments, input frames are binary matrices where elements having a certain binary value, illustratively a logic 0 value, correspond to objects having a large distance from a camera. Elements having the complementary binary value, illustratively a logic 1 value, correspond to distances below some threshold distance value. One visible object such as a hand is typically represented as one continuous blob having one outer contour. In some instances, a single solid object may be represented by two or more blobs or portions of a single blob may represent two or more distinct objects.

Block 202 in some embodiments further includes valid contours selection and/or contour regularization. Valid contours may be selected by their respective lengths. For example, a separated finger should have enough contour length to be accepted, but stand-alone noisy pixels or small numbers of stray pixels should not.

Block 202 may also include application of one or more contour regularization techniques in some embodiments. Examples of such contour regularization techniques will be described in further detail below.

In block 204, feature points are selected from one or more of the contours extracted in block 202. A contour C may be represented by coordinates in a 2D or 3D plane. As an example, a 2D plane in a Cartesian coordinate system may have axes OX and OY. In this coordinate system, the contour C may be defined as an ordered sequence of coordinate points p₁, . . . , pₗ where pᵢ=(xᵢ,yᵢ) and 1≦i≦l. The last point pₗ is followed by the first point pₗ. k is used to denote the size of a neighborhood of a point. The values of l and k may be varied according the needs of a particular application or the capabilities of a particular image processor. In some embodiments, 300≦l≦500 and k=10.

Point selection in block 204 may involve calculating k-cosine values for each point of C according to

vᵢₖ=pᵢ−pᵢ₊ₖ=(xᵢ−xᵢ₊ₖ,Yᵢ−Yᵢ₊ₖ),

wᵢₖ=pᵢ−pᵢ₋ₖ=(xᵢ−xᵢ₋ₖ,Yᵢ−Yᵢ₋ₖ),

where indexes are modulo and the k-cosine at pᵢ is calculated according to

$${cos}_{ik} = \frac{{v}_{ik} \cdot {w}_{ik}}{\vert {v}_{ik} \vert \vert {w}_{ik} \vert} .$$

The difference of k-cosine values is calculated according to

diff_{i,k}=1/k(cos _{i,k}−cos _{i-k,k}).

Block 204 in some embodiments selects points which meet threshold conditions. For example, T₁ is a subset of points which corresponds to a neighborhood of local maximum in the sequence of k-cosine values. In some embodiments, T₁ is defined according to

T₁={pᵢ∈C|(diff_{i,k}>trₖ)&(diff_{i+k,k}<−trₖ)},

where trₖ is a first parameter of sensitivity. T₂ denotes a subset of points which correspond to a neighborhood of local minimum in the sequence of k-cosine values. In some embodiments, T₂ is defined according to

T₂={pᵢ∈C|(diff_{i,k}<tr′ₖ)&(diff_{i+k,k}>−tr′ₖ)},

where tr′ₖ is a second parameter of sensitivity.

In some embodiments, feature points are selected from subsets T₁ and T₂ of C. Points of T₁ and T₂ are typically located in regions where the contour C has relatively high curvature and relatively low curvature, respectively. Feature points in some embodiments are selected from areas of relatively high densities of points in T₁ and T₂, respectively. These high density regions may have gaps due to noise and may be of different size. In some embodiments, normalization techniques are applied to the high density regions. Feature points may be selected as a middle or near middle point of a normalized high density region.

As an example, gap removal is one normalization technique which may be used. An index s is used to denote the set T₁ or T₂. A new set \tilde{T}ₛ is obtained after gap removal. \tilde{T}ₛ includes points from Tₛ and one or more other points from C whose left and right neighborhoods of radius r both contain a number of points from Tₛ above threshold tr″ₖ. The radius r and threshold value tr″ₖ are given as parameters, e.g., r=k/2 and tr″ₖ=0.

As another example, region length normalization may be applied. Region length normalization adds some points before and after a given high density region such that the high density region has a target length 2 h. Rₛ is a region of type s in C:

Rₛ=pᵢ₋ₕ, . . . ,pᵢ, . . . ,pᵢ₊ₕ

where i is an index in C=p₁, . . . ,pₗ of a middle point of a normalized high density region in Tₛ. pᵢ₋ₕ and pᵢ₊ₕ are the start and end points of the region, respectively. pᵢ is used to denote a feature point corresponding to Rₛ. Rₛ is referred to herein as a region of support for the feature point pᵢ.

In some embodiments, a feature vector includes one or more of:

1. Point coordinates pᵢ₋ₕ, pᵢ and pᵢ₊ₕ.

2. A direction

$${d}_{i} = \frac{{p}_{i + h} - {p}_{i - h}}{\vert {p}_{i + h} - {p}_{i - h} \vert} .$$

The direction feature is useful in cases where coordinates have small weights during subsequent matching procedures.

3. Convexity sign cᵢ. The convexity sign cᵢ may be determined as follows. For a positive 3D Cartesian coordinate system in which axes OX and OY belong to a frame plane, let A=pᵢ−pᵢ₋ₕ and B=Pᵢ₊ₕ−Pᵢ₋ₕ. FIG. 3 shows an example of the positive 2D Cartesian coordinate system. Vector components of A and B are denoted A=(Aₓ, A_{y}, A_{z}) and B=(Bₓ, B_{y}, B_{z}). A function S(x) is defined as follows

$$S ( x ) = \{ \begin{matrix}+ 1 x \geq 0 \\ - 1 x < 0\end{matrix} .$$

The convexity sign cᵢ is defined as

cᵢ=S(AₓB_{y}−A_{y}Bₓ).

AₓB_{y}−A_{y}Bₓ is the third component in a vector cross product

A×B=(A_{y}B_{z}−A_{z}B_{y},A_{z}Bₓ−AₓB_{z},AₓB_{y}−A_{y}Bₓ)=(0,0,AₓB_{y}−A_{y}Bₓ).

A cross product a×b is defined as a vector c that is perpendicular to both a and b, with a direction given by the right-hand rule and a magnitude equal to the area of the parallelogram that the vectors a and b span. cᵢ≧0 if vectors A and B have nonnegative orientation. FIG. 3 shows examples of positive and negative convexity signs for a contour.

4. Additional features used to increase the selectivity of a match between feature points. As an example, additional features may include the k-cosine at pᵢ.

In some embodiments, two types of features vectors are defined. Pᵢ₋ₕ=(xᵢ₋ₕ,yᵢ₋ₕ) pᵢ=(xᵢ,yᵢ) and Pᵢ₊ₕ=(xᵢ₊ₕ,yᵢ₊ₕ) A first feature vector V₁ is defined as

V₁=(xᵢ₋ₕ,yᵢ₋ₕ,xᵢ,yᵢ,xᵢ₊ₕ,yᵢ₊ₕ,dᵢ,cᵢ)

and a second feature vector V₂ is defined as

V₂=(xᵢ₋ₕ,yᵢ₋ₕ,xᵢ,yᵢ,xᵢ₊ₕ,yᵢ₊ₕ,dᵢ)

Feature vectors V₁ and V₂ correspond to T₁ and T₂, respectively. In some embodiments the feature vector V₂ does not contain convexity sign cᵢ as the curvature for feature points of this type is typically small and thus due to residual noise cᵢ may be random. Feature vectors for a number of frames may be stored in the memory 122.

Intersection of objects is detected in block 206. In some embodiments, tracking of objects is initialized responsive to detecting intersection of objects in block 206. In other embodiments, tracking may be performed for one or more frames where objects do not intersect one another in addition to or in place of performing tracking in one or more frames were objects do intersect one another. In addition, block 206 may check conditions for tracker initialization based on particular types of intersection. Block 202 may extract contours for a plurality of objects from one or more images. As one example, block 202 may extract a contour for a left hand, a contour for a right hand and a contour for one or more other objects such as a chair, table, etc. In some embodiments, block 206 checks for intersection of two or more particular ones of the objects, such as the left hand and the right hand, while ignoring intersection of other objects. Various other examples are possible, e.g., checking for intersection of any two objects.

Intersection detection in block 206 may be based on one or more conditions. In some embodiments, a number of contours extracted from a given frame are used to detect intersection. For example, if one or more previous frames extracted two contours representing a left hand and a right hand while only one contour is extracted from the given frame, block 206 detects intersection of objects, namely, the left hand and the right hand. In other embodiments, various other conditions may be used to detect intersection, including but not limited to contour location in a frame and the numbers and coordinates of local minimums and local maximums in the given frame. Listed values for the number of contours, contour locations, local minimums and local maximums, etc. may be compared to various thresholds to detect intersection in block 206.

Block 208 performs tracking of objects. As described above, block 208 may perform tracking responsive to detecting intersection of objects in block 206. Tracking in block 208 in some embodiments aims to keep accurate information of some class(es) of feature points. For example, tracking may seek to accurately identify feature point correspondence to one or more known objects, such as a left hand or a right hand. Tracking block 208 calculates a transformation of hand coordinates having sets of matching feature points which correspond to a same known hand in different frames. Tracking block 208 in the process 200 includes predicting point coordinates in block 210, matching points in block 212 and managing points in block 214.

Point coordinate prediction in block 210 involves estimating coordinates of feature points as coordinates change from frame to frame. In some embodiments, respective start and end points of corresponding regions of support for the feature points are also estimated as features points change in time from frame to frame. Block 210 provides coordinate estimates pointing to where a given point from a previous frame is predicted to be in a current frame. In some embodiments, the estimates are based on an assumption that coordinates in subsequent or consecutive frames will vary by less than a threshold distance. Thus, coordinate changes of feature points is limited. This technique is referred to herein as basic point coordinate prediction. As one example, the coordinates of feature points in a previous frame are used as an estimate for coordinates of feature points in a current frame.

In other embodiments, point coordinate prediction may be performed using a history of feature point coordinates for a number of previous frames is saved in memory 122. Such techniques are referred to herein as advanced point coordinate prediction, and will be described in further detail below.

Block 212 matches coordinates of points in a current frame to predicted coordinates of feature points from contours in one or more previous frames. In the example that follows, it is assumed that left and right hands are intersected in the current contour. Embodiments, however, are not limited solely to tracking hands. Instead, embodiments may track various other objects in addition to or in place of hands.

In some embodiments, matcher block 212 obtains feature vector lists L_{current,1} and L_{current,2} which are calculated for the contour of a current frame. The current contour is assumed to represent intersected objects. Block 212 also obtains feature vector lists calculated for previous frames which are stored in memory 122. In some embodiments, the lists include L_{left,1} and L_{left,2} containing feature vectors which correspond to the left hand and L_{right,1} and L_{right,2} containing feature vectors which correspond to the right hand. The numerical indexes 1 and 2 denote the types of feature vectors, e.g., V₁ and V₂. Lists L_{left,1}, L_{left,2}, L_{right,1} and L_{right,2} are initialized when contours of the left and right hand are separated. In some embodiments, feature vectors may not be separated into two different types, and thus the list of current feature vectors is not split by indexes 1 and 2. In other embodiments, only feature vectors of a given type are used for matching, e.g., feature vectors for index 1 or index 2.

Matching block 212 searches for matching feature vectors by comparing current feature vectors in L_{current,1} to L_{left,1} and L_{right,1}, and by comparing current feature vectors in L_{current,2} to L_{left,2} and L_{right,2}. If a feature vector V from the current list L_{current,s} is the closest to some feature vector W from stored list L_{left,s} and the distance between the vectors is less than D, the vector V belongs to the new list for the left hand and is the matching vector for W. More formally,

$${L}_{left , s}^{new} = \{ \begin{matrix}V ∈ {L}_{current , s} \vert ∃ W ∈ {L}_{left , s} \\ V = {arg min}_{\hat{V} ∈ {L}_{current , s}} {d}_{s} ( \hat{V} , W ) \& {d}_{s} ( V , W ) < D\end{matrix} \} ,$$

similarly for the right hand class

$${L}_{right , s}^{new} = \{ \begin{matrix}V ∈ {L}_{current , s} \vert ∃ W ∈ {L}_{right , s} \\ V = {arg min}_{\hat{V} ∈ {L}_{current , s}} {d}_{s} ( \hat{V} , W ) \& {d}_{s} ( V , W ) < D\end{matrix} \}$$

where s is type 1 or 2, D is a threshold parameter which defines match accuracy and dₛ is a distance measure.

The distance d₁ is determined according to

$${d}_{1} ( V , W ) = \{ \begin{matrix}\begin{matrix}∞ & if {V}_{c} \neq {W}_{c} \\ \sqrt{{\sum }_{k} {{w}_{k} ( {V}_{k} - {W}_{k} )}^{2}} & if {V}_{c} = {W}_{c}\end{matrix} , & \end{matrix}$$

where V_{c} denotes a convexity sign taken from a feature vector V, W_{c} denotes a convexity sign taken from a feature vector W, wₖ denotes weights assigned to vector elements, and Vₖ and Wₖ are respective elements of the feature vectors V and W, except V_{c} and W_{c}.

The distance d₂ is determined according to

$${d}_{2} ( V , W ) = \sqrt{{\sum }_{k} {{w}_{k} ( {V}_{k} - {W}_{k} )}^{2}} ,$$

where wₖ denotes weights assigned to vector elements and Vₖ and Wₖ are respective elements of the feature vectors V and W. In the advanced point coordinate prediction technique which will be described in further detail below, the features vectors in lists L_{left,1}, L_{left,2}, L_{right,1} and L_{right,2} may include estimates of future feature point coordinates in addition to or in place of feature point coordinates of previous frames. This allows for matching points in block 212 in cases where a series of frames have significant differences due to fast hand or other object motion.

Block 214 manages feature points which are used for point coordinate prediction in block 210 and matching in block 212. Block 214 removes and adds feature points and corresponding feature vectors from memory 122 during tracking Responsive to matching in block 212, block 214 may update feature vectors. Updating feature vectors may include removing one or more features for feature points in contours having predicted coordinates that do not match coordinates of points in a current frame within a defined threshold. Updating feature vectors may also or alternatively include adding one or more features for points in a current frame that do not match predicted coordinates of feature points from one or more previous frames within the defined threshold.

During initialization, contours are assumed to represent separate objects such as separate left and right hands. The lists L_{left,1}, L_{left,2}, L_{right,1} and L_{right,2} are stored in memory 122. When hands are intersected, newly matched feature vectors are stored in the appropriate list. Newly matched feature vectors may result from matching some vector from a previous frame which provides information about the class of a current vector and corresponding feature point.

Some feature vectors from a previous frame may not match any vector from a current frame. In some embodiments, such feature vectors are not used for further processing, e.g., for tracking in one or more subsequent frames. This may involve removing such feature vectors from corresponding ones of L_{left,1}, L_{left,2}, L_{right,1} and L_{right,2}.

In other embodiments, feature vectors which do not match any vector from a current frame may be used for subsequent frames. This may involve leaving such feature vectors in corresponding ones of L_{left,1}, L_{left,2}, L_{right,1} and L_{right,2} for at least one subsequent frame. In some cases, the feature vectors which do not match any vector from a current frame are stored in corresponding ones of L_{left,1}, L_{left,2}, L_{right,1} and L_{right,2} for a threshold number of subsequent frames. If the feature vectors do not match in at least one of the threshold number of subsequent frames, the feature vectors may be removed from corresponding ones of L_{left,1}, L_{left,2}, L_{right,1} and L_{right,2}. Thus, tracking may be continued for some time or series of frames without data confirmation or matching of particular feature points or feature vectors.

Block 214 may also manage feature points by adding new feature points which are initialized in block 216. In block 216, new feature points are initialized while objects are intersected. The new feature points in some embodiments correspond to points in a current frame which do not match feature points from one or more previous frames. Block 216 is an optional part of the process 200, which may be useful in cases in which block 214 loses or removes some feature points during tracking, or when previously obscured or unmatched feature points in a previous frame reappear in a subsequent frame. Some parts of a contour may transition from being visible to being invisible and back to being visible in a series of frames.

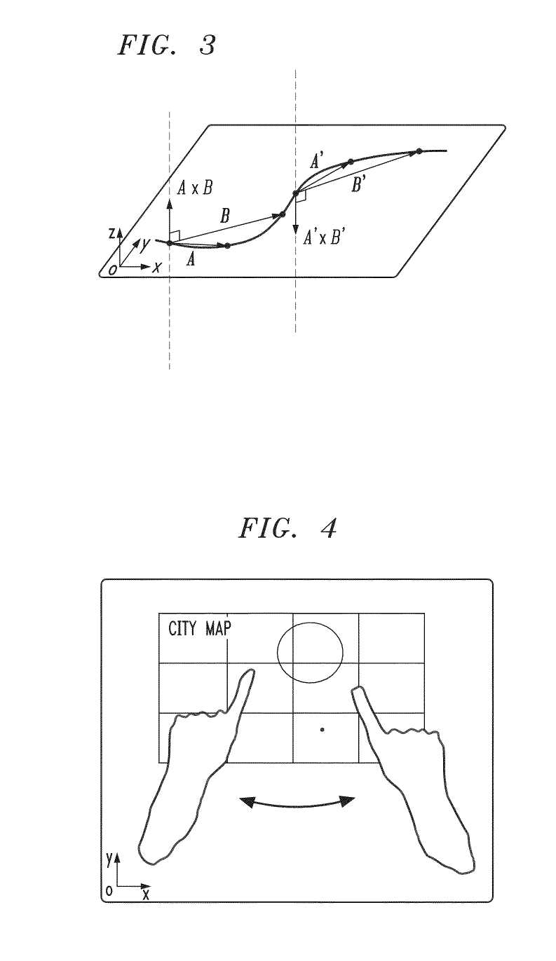

FIG. 4 shows an example of gestures which may be performed for a map application. The map application is an example of one of the GR applications 118. To perform certain gestures on the map application, a user moves left and right hands in respective pointing-finger poses to zoom in and out of a map. FIGS. 5-7 shows images of the left and right hands which may be captured when a user is performing this gesture for the map application in FIG. 4. FIG. 5 shows the left and right hands as separate from one another. Feature points and feature vectors may be defined in block 204 using contours for the left and right hands shown in FIG. 5 which are extracted in block 202.

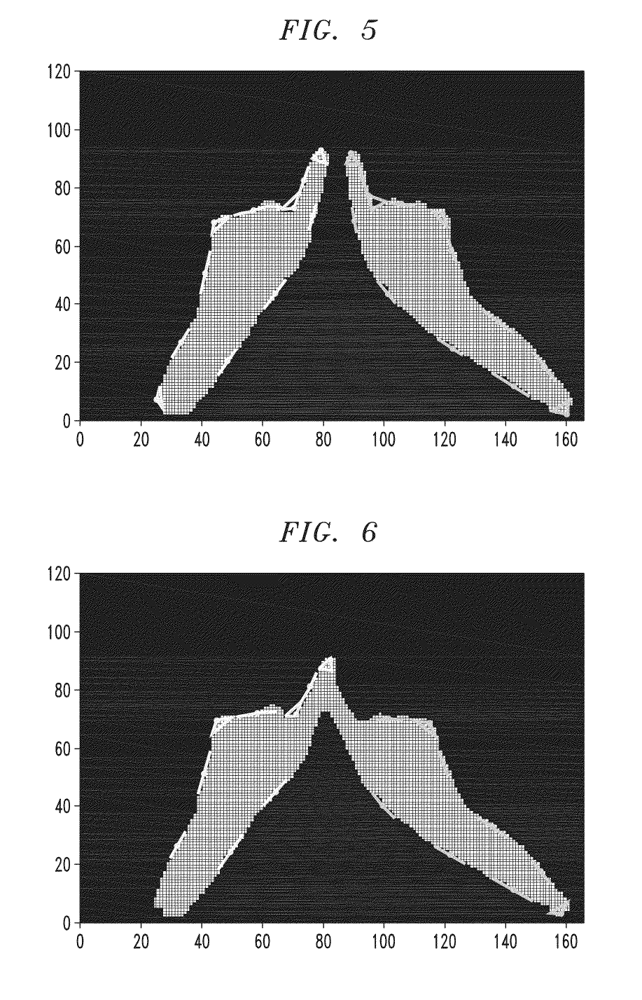

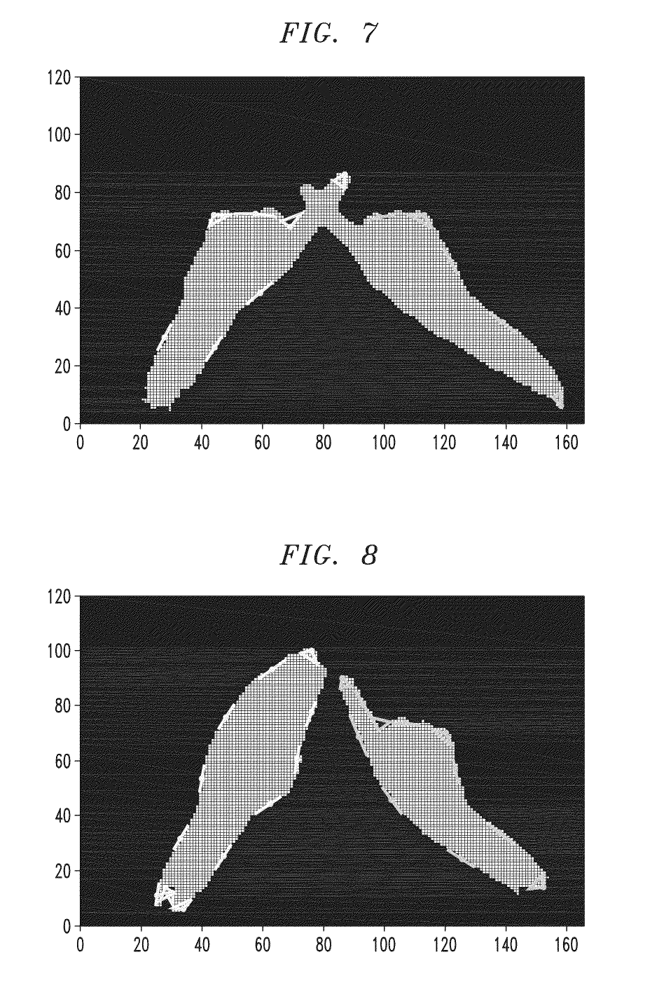

FIG. 6 shows an image in which the left and right hands intersect one another. In FIG. 6, the pointer finger of the right hand intersects the pointer finger of the left hand. Thus, some feature points of the right hand, such as feature points for the top of the right pointer finger, which were visible in the image of FIG. 5, are no longer visible in the image of FIG. 6. FIG. 7 shows another image where the left and right hands intersect one another. In the FIG. 7 image, the feature points for the top of the right pointer finger are once again visible.

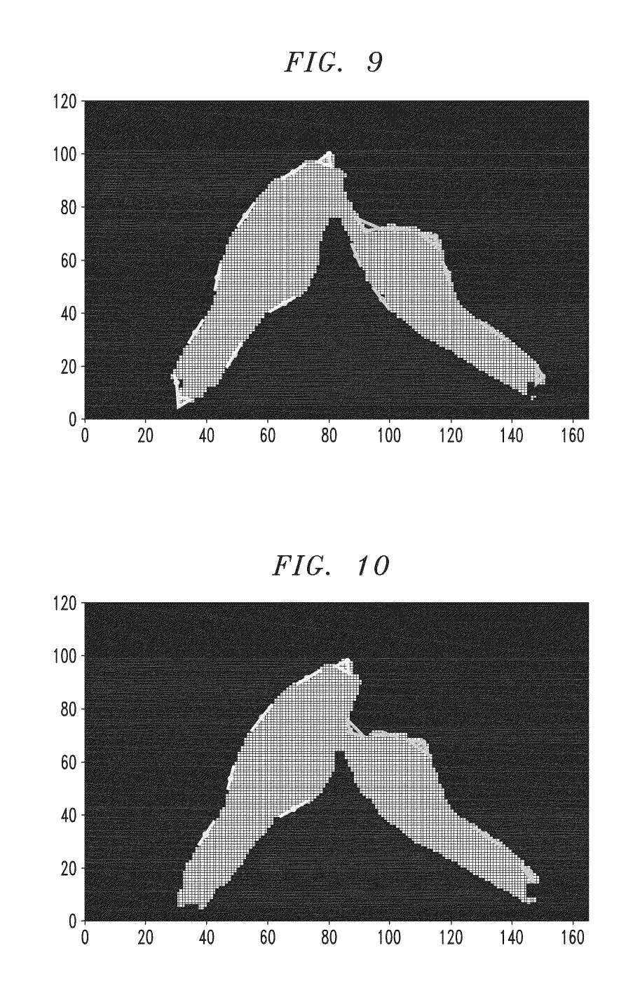

FIG. 8 shows an image of a left hand in an open-palm pose and a right hand in a pointing finger pose. A user may utilize these poses for gestures in the map application of FIG. 4 other than zooming in or zooming out, or for a different one of the GR applications 118. FIGS. 9-11 show additional images where the left and right hands in FIG. 8 intersect one another.

In some embodiments, information about points may be obtained from an external source. Exemplary techniques for obtaining such information from an external source are described in Russian Patent Application identified by Attorney Docket No. L13-1315RU1, filed Mar. 11, 2013 and entitled “Image Processor Comprising Gesture Recognition System with Hand Pose Matching Based on Contour Features,” which is commonly assigned herewith and incorporated by reference herein.

As described above, various contour regularization techniques may be applied to contours in block 202. A variety of techniques may be used to extract contours from black-and-white, grayscale and color images. Such techniques are subject to image noise amplification due to gradient-based operating principles, which can result in ill-defined, ragged contours. Noisy contours may lead to object misdetection, mistaken merging of blobs into a single contour, mistaken separation of blobs corresponding to a single object into separate contours, unstable feature points, etc. Feature points which are otherwise well-defined may become subject to drift, emersion and disappearance which result in false feature points. The use of false or unstable feature points can impact subsequent tracking of objects using such feature points. Contour regularization techniques may be applied to noisy contours to address these and other issues.

In some embodiments, taut string (TS) techniques are used for contour regularization. TS regularization provides a number of advantages, including but not limited to efficient implementation of contour-specific defect elimination, feature preservation even at relatively high degrees of contour regularization, low computational complexity involving a linear function of processed contour nodes, ease of contour approximation, compact representation of resulting contours, etc.

TS regularization in some embodiments may be driven by a single parameter α≧0 which prescribes an amount of contour disturbance to eliminate. TS may be single-dimensional and applied to a scalar value w which is a function of another scalar value v, e.g., w(v). TS may be extended to a discrete, finite time series by using pairs of ordered samples (vₖ, wₖ) where k=1, . . . , K and vₖ<vₖ₊₁. FIG. 12 illustrates an example of the TS approach. FIG. 12 shows a plot of w(v) as well as w (v)+α and w(v)−α. Thus, the noisy function (vₖ, w(vₖ)) is shifted up by α and shifted down by α. The curves w(v)+α and w(v)−α define a kind of tube or tunnel of vertical caliber 2α. TS defines a minimal-size subset of (vₖ, wₖ) such that segments of straight lines connecting pairs of adjacent nodes (vₖ, wₖ) and (vₖ₊₁, wₖ₊₁) lie completely inside the tube or tunnel of vertical caliber 2α.

TS techniques can be used to eliminate small function variation while retaining sufficient feature points defining important characteristics of the contour. The parameter α may be adjusted to control TS deviation from the original contour. The number of residual nodes K_{TS}, represented by points in the curve TS(v,w(v),α) in FIG. 12, is less than the initial number of nodes K in curve w(v) in FIG. 12. The number of residual nodes K_{TS} generally decreases as the regularization parameter α increases.

In some embodiments, TS approaches are modified for use in regularizing blob contours. TS may be one-dimensional and require monotonic rise of v along a contour unfolding. Blob contours, however, are considered to be closed. Thus, Cartesian coordinates (x, y, z) of a blob contour run a complete cycle around the blob from an arbitrarily selected contour unfolding start node to an adjacent contour unfolding end node. Thus, coordinates change non-monotonically over the blob perimeter. Thus, in some embodiments modified TS is used for contour regularization. Two exemplary methods for blob contour parameterization are described below, both having low, e.g., linear in K, complexity. Various other contour regularization techniques may be applied in other embodiments.

The first method for blob contour parameterization utilizes flat contour representation in polar coordinates (φ, ρ), where φ denotes the contour path tracing angle, 0≦φ<2π, and ρ(φ)≧0 is the corresponding radius. co corresponds to the parameterization argument v and ρ corresponds to the dependent variable w. The first method is applicable to planar (x,y) contours. The selection of a starting angle, φ₀, is arbitrary. The coordinate center is chosen to ensure that ρ(φ) is a single-valued function even for blobs of complex shape.

In some embodiments, an arbitrary choice of coordinate center may be made for convex-shaped blobs, where across a series of frames the shape of the blob changes slightly. In order to keep the coordinate center geometrically stable, the polar coordinate center may be placed in a blob centroid point or an x-y median point. This coordinate center definition works well in most cases. In some cases where blobs are highly non-convex, alternate coordinate center definitions may be used.

The first method for blob contour parameterization may in some cases result in the addition of multiple synthetic contour nodes. Curve representation in polar coordinates converts a straight line segment into multiple convex and concave arcs, resulting in the addition of such synthetic contour nodes. Some synthetic nodes may not be eliminated using TS regularization. In such cases, the resulting contour representation after TS regularization may retain a number of the superfluous synthetic nodes.

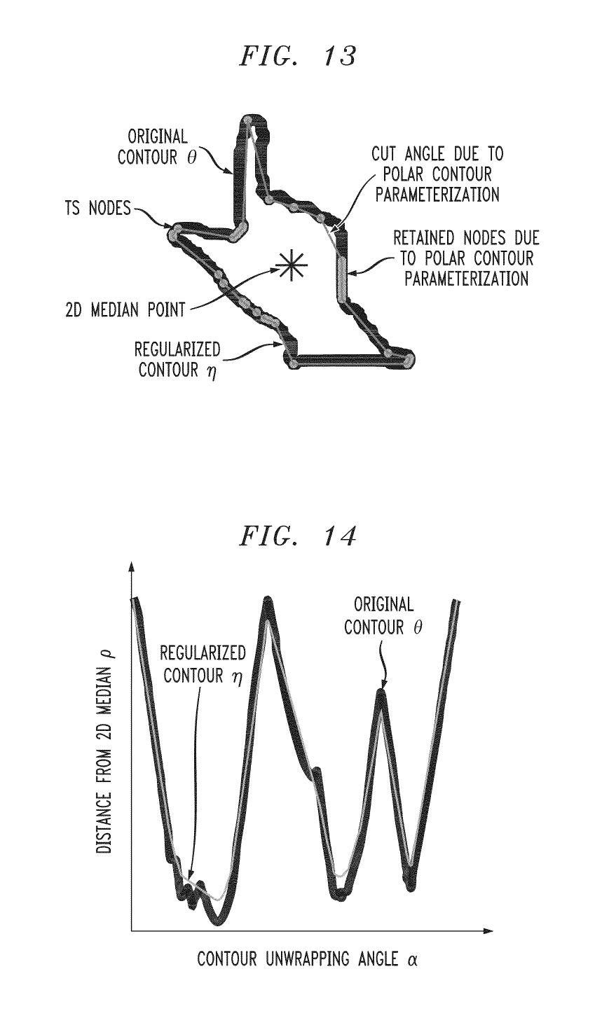

FIG. 13 illustrates an example of contour regularization using TS and polar coordinate unwrapping with the first method of blob contour parameterization. FIG. 13 shows an original contour θ of a right hand, and a regularized contour η of the right hand for a 2D median point selected as the polar coordinate center. As shown in FIG. 13, the first method of blob contour parameterization may result in a cut angle and retaining one or more superfluous synthetic nodes. FIG. 14 shows plots of the original contour θ and regularized contour η. FIG. 14 plots distance from the 2D median point shown in FIG. 13 as a function of the contour unwrapping angle α.

The second method for blob contour parameterization process Cartesian coordinates (x, y, z). The second method thus avoids the computationally demanding transition to and from polar coordinates used in the first method for blob contour parameterization, which involves calling functions arctan (y, x), sin(φ), cos(φ) and \sqrt{x²+y²} K times. The second method for blob contour parameterization in some embodiments proceeds as follows.

1. Sequential contour tracking is performed node-by-node for a contour until contour closure, e.g., k∈θ, θ={1, . . . , K} where θ is an ordered vector of input contour node indices. Step 1 produces topologically ordered coordinate vectors for coordinates in the contour description. In some embodiments, the starting node for the noisy contour unwrapping as well as the direction of unwrapping can be different for coordinates x, y and z if the nodes are listed in the same sequence as they appear in the contour. To simplify processing, some embodiments apply the same ordering for coordinates x, y and z. Further processing may be performed for each coordinate vector independently, allowing for efficient parallelization. Coordinates x, y and z are parameterized independently. v denotes an ordered node number k and w(v) if a fixed one of the node coordinates (x, y, z), e.g., w(v)=x(k) or w(v)=y(k) or w(v)=z(k).

2. For each coordinate x, y and z, TS is applied with a respective parameterization value αₓ, α_{y} and α_{z}. By using different parameters for different coordinates, the amount of noise and raggedness suppression may be adapted providing advantages in cases where the uncertainties for the coordinates are different. In many 3D imagers, such as those which use ToF, SL or triangulation technologies, depth measurements lead to lower precision in z coordinates relative to x and y coordinates. Thus, α_{z} may be set to a higher value than αₓ or α_{y} in some embodiments. The coordinate-wise results are separate TS-reduced vectors for coordinates of the regularized contour:

η_{TSx}=TS(θ,x(θ),αₓ),

η_{TSy}=TS(θ,y(θ),α_{y}), and

η_{TSz}=TS(θ,z(θ),α_{z}).

It is important to note that the lists η_{TSx}∈θ, η_{TSy}∈θ and η_{TSz}∈θ need not be identical. This does not represent a problem for further processing, as it can yield better contour compression and better feature point selection by locating stable feature points.

3. The regularized contour is reconstructed using TS nodes from index sets η_{TSx}, η_{TSy} and η_{TSz} as follows:

(i) Process indices belonging to at least one partial TS:

m∈{η_{TSx}∪η_{TSy}∪η_{TSz}}.

(ii) Select nodes where index m satisfies m∈η_{TSx}, m∈η_{TSy} and m∈η_{TSz} for the regularized contour.

(iii) For indexes where m does not satisfy at least one of m∈η_{TSx}, m∈η_{TSy} and m∈η_{TSz}, interpolate a missing value of x_{TS}(k) where m∉η_{TSx}, a missing value y_{TS}(k) where m∉η_{TSy}, or a missing value z_{TS}(k) where m∉η_{TSz}. In some embodiments these interpolations use a linear index-oriented model supported by the TS approach. x_{TS}(m) may be calculated according to

$${x}_{TS} ( m ) = {x}_{TS} ( argmax ( j ∈ {η}_{TSx} , j < m ) ) + \frac{{x}_{TS} ( argmin ( j ∈ {η}_{TSx} , j > m ) ) - {x}_{TS} ( argmax ( j ∈ {η}_{TSx} , j < m ) )}{( argmin ( j ∈ {η}_{TSx} , j > m ) - ( argmax ( j ∈ {η}_{TSx} , j < m )} ( m - argmax ( j ∈ {η}_{TSx} , j < m ) ) .$$

Similarly, Y_{TS}(m) may be calculated according to

$${y}_{TS} ( m ) = {y}_{TS} ( argmax ( j ∈ {η}_{TSy} , j < m ) ) + \frac{{y}_{TS} ( argmin ( j ∈ {η}_{TSy} , j > m ) ) - {y}_{TS} ( argmax ( j ∈ {η}_{TSy} , j < m ) )}{( argmin ( j ∈ {η}_{TSy} , j > m ) - ( argmax ( j ∈ {η}_{TSy} , j < m )} ( m - argmax ( j ∈ {η}_{TSy} , j < m ) ) .$$

z_{TS}(m) may be calculated according to

$${z}_{TS} ( m ) = {z}_{TS} ( argmax ( j ∈ {η}_{TSz} , j < m ) ) + \frac{{z}_{TS} ( argmin ( j ∈ {η}_{TSz} , j > m ) ) - {z}_{TS} ( argmax ( j ∈ {η}_{TSz} , j < m ) )}{( argmin ( j ∈ {η}_{TSz} , j > m ) - ( argmax ( j ∈ {η}_{TSz} , j < m )} ( m - argmax ( j ∈ {η}_{TSz} , j < m ) ) .$$

Interpolation ensures that restored nodes lie along TS line segments.

In some embodiments, alternatives to interpolation are used for one or more of the indexes. x_{TS}(k), y_{TS}(k) and z_{TS}(k) may be obtained by taking original contour nodes which do not necessarily lie along or belong to TS segments as follows:

x_{TS}(m)=x(k₁),

y_{TS}(m)=y(k₂), and

z_{TS}(m)=z(k₃),

where k₁, k₂, k₃∈θ. These embodiments involve a lower computational budget relative to embodiments which utilize interpolation at the expense of some contour regularization and compression quality degradation.

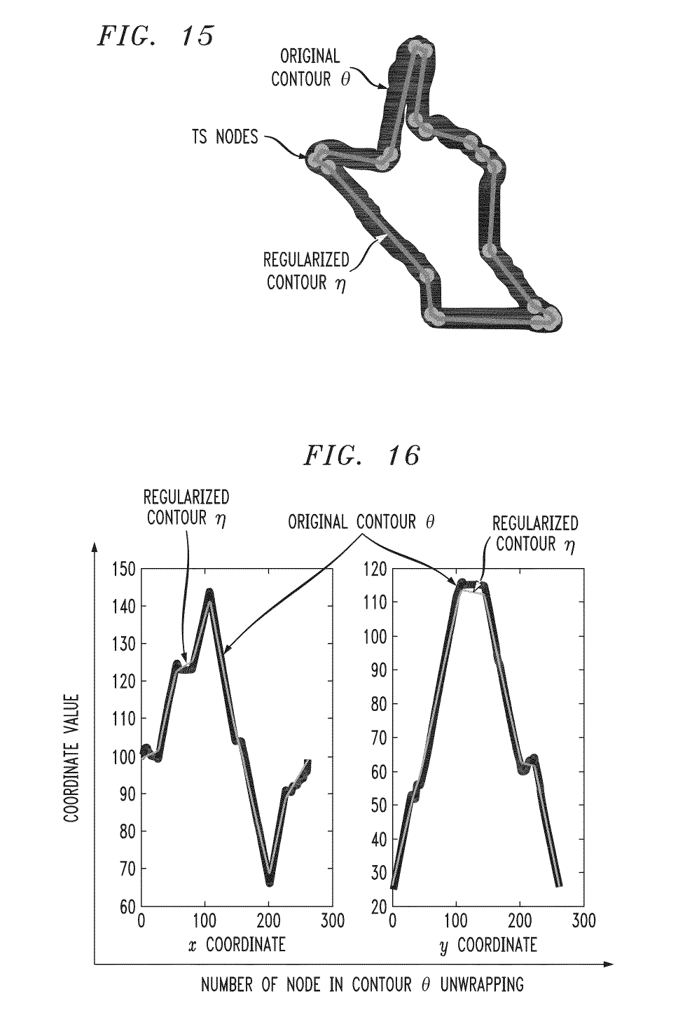

FIG. 15 illustrates an example of contour regularization using TS and independent coordinate processing with the second method of blob contour parameterization. FIG. 15 shows an original contour θ of a right hand, and a regularized contour η of the right hand. FIG. 16 shows plots of the original contour θ and regularized contour η for the x coordinate and y coordinate, respectively. The plots in FIG. 16 are shown as plots of coordinate values as a function of the number of respective nodes in the contour θ unwrapping.

TS, as discussed above, may be used to locate stable feature points. Contour regularization using TS can eliminate noise-like contour jitter and raggedness while preserving major shape patterns such as locally convex parts (e.g., protrusions), locally concave portions (e.g., bays) and corners. These types of medium-to-large scale details provide features which may be used to pinpoint an object shape for subsequent recognition and tracking TS techniques used in some embodiments model these localized places of relatively high curvature as clusters of straight line segment joints. Conversely, noise-like contour jitter and raggedness of insufficient curvature are approximated with relatively sparse straight line breaks. Candidates for stable feature points in some embodiments are located in places where two adjacent TS segments meet at an acute angle for one or more coordinates or exhibit breaks for multiple coordinates in the same topological vicinity.

In some embodiments, assumptions are made to reduce the number of possible candidates for stable feature points. For example, in some cases the cardinality of the TS output node set θ is assumed to be much less than the cardinality of η, i.e., (K_{TS}≡card(θ))<<(K≡card(η)). This assumption helps to locate stable feature points by considerably reducing the number of candidates.

The first and second methods for blob contour parameterization can each provide advantages relative to one another. For example, the second method for blob contour parameterization has higher TS-related complexity relative to the first method for blob contour parameterization. The second method for blob contour parameterization, however, can support more than two dimensions and allow for efficient parallelization of computations. In addition, the second method for blob contour parameterization allows more flexibility in contour shapes, e.g., contours may not be planar in 3D and may have complex forms and be arcuate or twisted. More generally, the second method for blob contour parameterization better supports arbitrary blob shapes relative to the first method for blob contour parameterization. The second method for blob contour parameterization in some embodiments involves more computation than the first method, but does not involve the computation of numerically expensive functions and avoids the computation of a blob centroid or median point calculation.

As described above, some embodiments may use techniques referred to herein as advanced point coordinate prediction in blocks 208-216 in the process 200. Point coordinate tracking allows stable and noise-resistant tracking of smooth motion of a point in a multidimensional metric space based on known point coordinates in previous frames or previous points in time. Advanced point coordinate prediction uses a number of recent noisy positions of a given point including a current noisy position of the given point taken from a sequence of frames or images. Advanced point coordinate prediction uses these noisy samples to estimate a true current-time position of the given point and to model future coordinates of the given point.

Advanced point coordinate prediction in some embodiments does not require motion or matching analysis. Instead, point coordinate tracking using advanced point coordinate prediction in some embodiments uses low-latency and low-complexity tracking of coordinate evolution over a series of frames. While described below primarily with respect to tracking a single point for clarity of illustration, point coordinate tracking using advanced point coordinate prediction can be extended to tracking multiple points of a blob such as the feature points of a blob. In addition, in some embodiments advanced point coordinate prediction may be used for some feature points while the above-described basic point coordinate prediction is used for other feature points. For example, in some embodiments a relatively small number of feature points may be tracked using advanced point coordinate prediction relative to a number of points tracked using basic point coordinate prediction.

In the examples of advanced point coordinate prediction described below, point motion is represented as a change in point location in Cartesian coordinates over time. Embodiments, however, are not limited solely to use with the Cartesian coordinate system. Instead, various other coordinate systems may be used, including polar coordinates.

Point coordinate tracking using advanced point coordinate prediction will be described in detail using frame-by-frame data where data processing is performed in discrete time. For clarity of illustration in the example below, it is assumed that the frames provide temporally equidistant coordinate values. Embodiments, however, are not limited solely to use with frame-by-frame data of temporally equidistance coordinate values.

In some embodiments, advanced point coordinate prediction independently tracks the evolution of coordinates for feature points, e.g., separately tracks x, y and z coordinates. Independent tracking of coordinates for feature points allows for gains in computation parallelization. In addition, computational complexity scaling in the multidimensional case is linear. Thus, point coordinate tracking may be mathematically described using a one-dimensional case. In the description that follows, w represents a single parameter or coordinate that is tracked over time. For a given number L of most recent time points tᵢ there are noise-affected coordinate samples wᵢ. The value of L is not necessarily fixed. Point coordinate tracking uses a time axis which is backwards in time, e.g., from the future to the past. Given a most recent known noisy point, advanced point coordinate prediction seeks to predict the corresponding point coordinate at index 0.

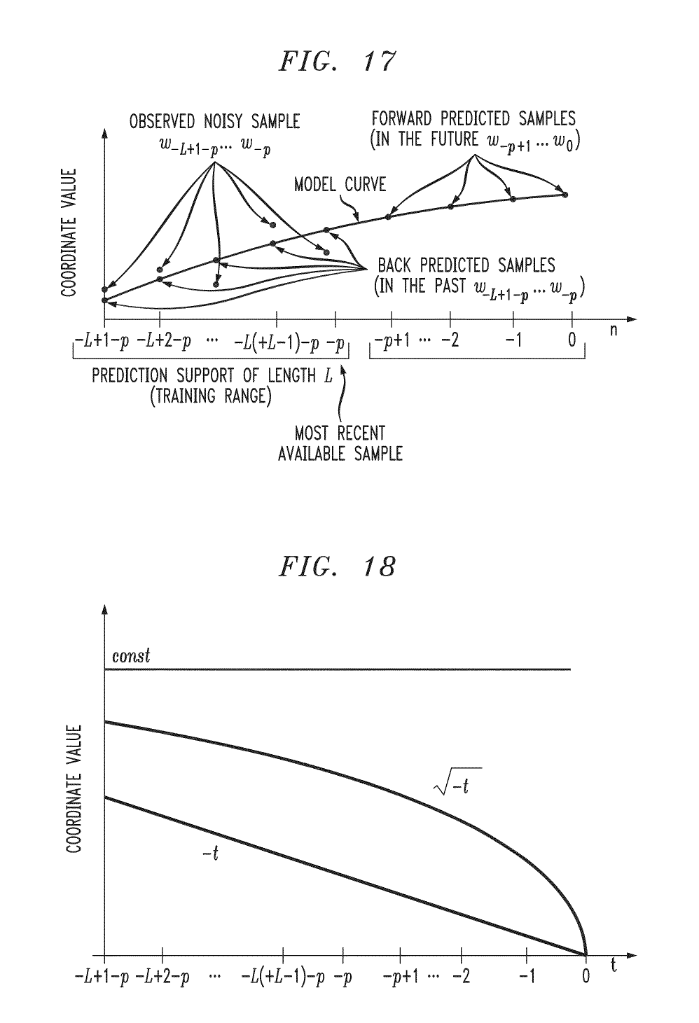

FIG. 17 shows an example of point coordinate tracking using advanced point coordinate prediction. In FIG. 17, L known noisy points w_{-L+1-p}, . . . , w₋ₚ are plotted over time, with a most recent known noisy sample being assigned index −p. −L+1−p, . . . , −p is the training range, or prediction support of length L. The points in FIG. 17 are plotted as coordinate values as a function of time. Advanced point coordinate prediction predicts point coordinates w₋ₚ₊₁, . . . , w₀ at future time indexes −p+1, . . . , −2, −1, 0. As shown in FIG. 17, a model curve is estimated using the known noisy samples. The set of L existing samples are smoothed to points on the model curve, which is then used to predict future points coordinates w₋ₚ₊₁, . . . , w₀.

In some embodiments, advanced point coordinate prediction utilizes aspects of a least mean squares (LMS) method for describing the evolution of w. The evolution of w in time may be an arbitrary linear composition of functions for a time argument t. Point coordinate tracking in some embodiments restricts such decomposition functions to a set including a constant function and one or more other functions. In some embodiments, the other functions have the following set of properties: the other functions are monotonic functions; the other functions have either zero or a small magnitude in the vicinity of t=0; the other functions have a magnitude that rises with departure from zero not faster than the square of t; and the first and higher derivatives of the other functions have magnitudes that are relatively small in the vicinity of t=0. In other embodiments, the other functions may have additional properties in place of or in addition to these properties. The other functions may alternatively have some subset of the above-described properties.

FIG. 18 shows one example set of functions, which includes a constant function denoted const, a linear function −t

\tilde{w}(t)=a−b·t

and a function \sqrt{−t}

\tilde{w}(t)=a+b·\sqrt{−t−c·t}

where a, b and c are model coefficients. Embodiments are not limited solely to the set of functions shown in FIG. 18. Various other functions may be used in place of or in addition to the functions shown in FIG. 18. In addition, some embodiments may use a subset of the functions shown in FIG. 18, such as the constant function const and the linear function −t.

Advanced point coordinate prediction in some embodiments sets the time axis direction backwards as described above. Setting the time axis direction backwards and using LMS decomposition functions having the above-described properties provides a number of computational complexity advantages. For example, the decomposition functions have relatively small or minimal magnitude deviation inside a forward prediction range, e.g., t=(−p+1), . . . , 0. This can significantly minimize model-related prediction instability, as LMS finds model coefficients based on relatively large values of decomposition functions inside a training range, e.g., t=(−L+1−p), . . . , −p. Inside the forward prediction range, in contrast, the regressor functions tend to values at or near to zero. Thus, regardless of the value of model coefficients found using LMS, the predicted values are well bounded and stable without means to deviate from a LMS stable motion trajectory. As another example, the backward and forward predicted samples build a smooth curve in time without bursts. Such a smooth curve matches expected real-world scenarios. For example, points in a blob representing a hand are not capable of changing their positions instantaneously. Instead, such points gradually slide along a smooth line, depending on the frame rate. For a frame rate of 30-60 frames per second (fps), such smooth motion of blob points is observed.

To find the model coefficients, advanced point coordinate prediction in some embodiments uses a system of normal linear equations. For example, to find the model coefficients a, b and c of the decomposition functions shown in FIG. 18, a regression model uses equidistantly timed coordinate samples numbered with non-positive integers to solve the following

$$( \begin{matrix}L & {\sum }_{n = - L + 1 - p}^{- p} \sqrt{- t} & {\sum }_{n = - L + 1 - p}^{- p} - t \\ {\sum }_{n = - L + 1 - p}^{- p} \sqrt{- t} & {\sum }_{n = - L + 1 - p}^{- p} t & {\sum }_{n = - L + 1 - p}^{- p} {( - t )}^{3 / 2} \\ {\sum }_{n = - L + 1 - p}^{- p} - t & {\sum }_{n = - L + 1 - p}^{- p} {( - t )}^{3 / 2} & {\sum }_{n = - L + 1 - p}^{- p} {t}^{2}\end{matrix} ) \cdot ( \begin{matrix}a \\ b \\ c\end{matrix} ) = ( \begin{matrix}{\sum }_{n = - L + 1 - p}^{- p} {w}_{n} \\ {\sum }_{n = - L + 1 - p}^{- p} \sqrt{- t} \cdot {w}_{n} \\ {\sum }_{n = - L + 1 - p}^{- p} - t \cdot {w}_{n}\end{matrix} )$$

for the vector of model coefficients (a, b, c)^{T}. The left-side square matrix

$$R = ( \begin{matrix}L & {\sum }_{n = - L + 1 - p}^{- p} \sqrt{- t} & {\sum }_{n = - L + 1 - p}^{- p} - t \\ {\sum }_{n = - L + 1 - p}^{- p} \sqrt{- t} & {\sum }_{n = - L + 1 - p}^{- p} t & {\sum }_{n = - L + 1 - p}^{- p} {( - t )}^{3 / 2} \\ {\sum }_{n = - L + 1 - p}^{- p} - t & {\sum }_{n = - L + 1 - p}^{- p} {( - t )}^{3 / 2} & {\sum }_{n = - L + 1 - p}^{- p} {t}^{2}\end{matrix} )$$

is the same for all iterations while L and p remain constant. Using a pre-computed R⁻¹ allows for simplification of computation effort for each step according to

$$( \begin{matrix}a \\ b \\ c\end{matrix} ) = {R}^{- 1} \cdot ( \begin{matrix}{\sum }_{n = - L + 1 - p}^{- p} {w}_{n} \\ {\sum }_{n = - L + 1 - p}^{- p} \sqrt{- t} \cdot {w}_{n} \\ {\sum }_{n = - L + 1 - p}^{- p} - t \cdot {w}_{n}\end{matrix} )$$

to obtain as many as (L+p) predicted samples in both backward and forward prediction ranges, e.g., t=(−L+1−p), . . . , 0.

In some embodiments, further computation economization may be achieved for p=0 if the following conditions are met. First, all decomposition functions except the constant function const are chosen such that they are equal to zero at point t=0. FIG. 18 illustrates a set of decomposition functions which meets this condition. Second, point coordinate tracking seeks to find the predicted coordinate value of t=0 only. If these conditions are met, the predicted value \tilde{w}(t=0)≡a and it is sufficient to multiply the upper row of the pre-computed R⁻¹ by the right hand column in the above equation.

Various other techniques for advanced point coordinate prediction may be used in other embodiments. For example, Kalman filtering may be used in other embodiments in place of the above-described LMS approach. A comparison of examples of illustrative embodiments utilizing basic point coordinate prediction, advanced point coordinate prediction using the LMS approach, and a Kalman filter approach is shown in Table 1:

TABLE 1

| | Basic Point Coordinate | | |
|---|---|---|---|
| Approach | Prediction using linear | Advanced Point Coordinate | |
| (single iteration) | non-adaptive smoothing | Prediction using LMS | Discrete Kalman filter |
| Data Dimensionality | Arbitrary | Arbitrary | Arbitrary |
| System Model | Linear with highly | Nonlinear with less | Linear, even less |
| | conservative behavior, | conservative behavior, | conservative behavior, |
| | e.g., system parameters | e.g., system parameters | e.g., system parameters |
| | do not change in a fast | can change in a fast but | can change in a fast |
| | non-smooth manner | smooth manner | and non-smooth |
| | | | manner |
| System Parameters | Predefined | Blind, e.g., parameters | Initial parameters are |
| | | are unknown and | known or statistically |
| | | estimated on the fly | estimated a priori |
| Input data | Sequence of most | Sequence of most | Single most recent |
| | recent noisy samples | recent noisy samples | noisy sample |
| Data interdependence | No | No | Yes |
| along different | | | |
| dimensions | | | |
| Tracking latency | High | Low | Low |
| Computational | Low for temporally | Low for temporally | High, e.g., |
| complexity per | equidistant samples, | equidistant samples, | 8 (M × M)-matrix |
| iteration for tracking | e.g., | e.g., | multiplications, |
| M parameters | (M + 1) dot products of | (M + 1) dot products of | 1 (M × M)-matrix |
| simultaneously | L-entry vectors per | L-entry vectors per | inversion, |
| | iteration | iteration | 3 (M × M)-matrix |
| | | | additions, |
| | | | 2 (M × M)-matrix by |
| | | | vector multiplications, |
| | | | 2 M-entry vector |
| | | | additions per iteration |

The particular approach used for point coordinate tracking may be selected based on a number of factors, including available computational resources, desired accuracy, known input image or frame quality, etc. In addition, in some embodiments combinations of approaches may be used for tracking. As an example, Kalman filtering may be used for tracking if only a few or a single most recent noisy sample is available. As more noisy samples are obtained, tracking may switch to using basic or advanced point coordinate prediction approaches.

The particular types and arrangements of processing blocks shown in the embodiment of FIG. 2 is exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, some embodiments use feature-based tracking based on object contours which allows for proper recognition and tracking even for low resolution images, e.g., 150×150 pixels. In addition, feature-based tracking in some embodiments does not require detailed color or grayscale information but may instead use input frames of binary values, e.g., “black” and “white” pixels.

Different portions of the GR system 108 can be implemented in software, hardware, firmware or various combinations thereof. For example, software utilizing hardware accelerators may be used for some processing blocks while other blocks are implemented using combinations of hardware and firmware.

At least portions of the GR-based output 113 of GR system 108 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising the steps of:
obtaining one or more images;
extracting contours of at least two objects in at least one of the images;
selecting respective subsets of points of the contours for said at least two objects based at least in part on curvatures of the respective contours;
calculating features of the subsets of points of the contours for said at least two objects;
detecting intersection of said at least two objects in a given image; and
tracking said at least two objects in the given image based at least in part on the calculated features responsive to detecting intersection of said at least two objects in the given image;
wherein the steps are implemented in an image processor comprising a processor coupled to a memory.

2. The method of claim 1 wherein extracting contours comprises applying contour regularization to the contours for said at least two objects.

3. The method of claim 2 wherein applying contour regularization comprises applying taut string regularization to a given one of the contours using a parameter of contour disturbance by:
converting planar Cartesian coordinates of the given contour to polar coordinates using a selected coordinate center of the given contour; and
tracing a path of the given contour using the polar coordinates relative to the selected coordinate center to select taut string nodes of the given contour based at least in part on the parameter of contour disturbance.

4. The method of claim 2 wherein applying contour regularization comprises applying taut string regularization to a given one of the contours using parameters of contour disturbance αₓ, α_{y}, α_{z}, for respective three-dimensional Cartesian coordinates x, y, z of the given contour by:
tracing a path of the given contour in the three-dimensional Cartesian coordinates to identify respective taut string nodes for each of the x, y and z coordinates of the given contour based at least in part on αₓ, α_{y} and α_{z}, respectively; and
selecting taut string nodes of the given contour based at least in part on the identified taut string nodes for the respective x, y and z coordinates.

5. The method of claim 1 wherein selecting the respective subsets of points comprises calculating k-cosine values for points in the contours and selecting the subsets of points based at least in part on differences of k-cosine values for adjacent points in the respective contours.

6. The method of claim 5 wherein the respective subsets of points comprise:
one or more points of the respective contours associated with a relatively high curvature based at least in part on a comparison of the differences of k-cosine values and a first sensitivity threshold; and
one or more points of the respective contours associated with a relatively low curvature based at least in part on a comparison of the differences of k-cosine values and a second sensitivity threshold.

7. The method of claim 1 wherein the calculated features comprise feature vectors comprising:
coordinates of points characterizing respective support regions for points in the respective subsets; and
directions of points in the respective subsets determined using the points characterizing the respective support regions.

8. The method of claim 7 wherein the feature vectors further comprise convexity signs for respective points in the respective subsets determined using the points characterizing the respective support regions.

9. The method of claim 1 wherein detecting intersection of said at least two objects in the given image is based on at least one of:
a number of contours in the given image;
locations of contours in the given image; and
numbers and locations of local minimums and local maximums of contours in the given image.

10. The method of claim 1 wherein tracking said at least two objects comprises tracking said at least two objects in a series of images including the given image.

11. The method of claim 1 wherein tracking said at least two objects comprises:
estimating predicted coordinates of points of the contours of said at least two objects based at least in part on the calculated features and known positions of points of the contours of said at least two objects in one or more images other than the given image;
matching coordinates of one or more points in the given image to respective ones of the predicted coordinates; and
updating the calculated features responsive to the matching.

12. The method of claim 11 wherein updating the calculated features comprises removing one or more features for points in the contours for said at least two objects having predicted coordinates that do not match coordinates of one or more points in the given image within a defined threshold.

13. The method of claim 11 wherein updating the calculated features comprises adding one or more features characterizing convexity between points in the given image having coordinates that do not match predicted coordinates of points in the contours for said at least two objects within a defined threshold.

14. The method of claim 11 further comprising tracking said at least two objects in an additional image based at least in part on the updated calculated features.

15. An apparatus comprising:
an image processor comprising image processing circuitry and an associated memory;
wherein the image processor is configured to implement an object tracking module utilizing the image processing circuitry and the memory; and
wherein the object tracking module is configured:
to obtain one or more images;
to extract contours of at least two objects in at least one of the images;
to select respective subsets of points of the contours for said at least two objects based at least in part on curvatures of the respective contours;
to calculate features of the subsets of points of the contours for said at least two objects;
to detect intersection of said at least two objects in a given image; and
to track said at least two objects in the given image based at least in part on the calculated features responsive to detecting intersection of said at least two objects in the given image.

16. The apparatus of claim 15 wherein the object tracking module is configured to track said at least two objects by:
estimating predicted coordinates of points in the contours of said at least two objects based at least in part on the calculated features and known positions of points in one or more images other than the given image;
matching coordinates of one or more points in the given image to respective ones of the predicted coordinates; and
updating the calculated features responsive to the matching.

17. The apparatus of claim 16 wherein the object tracking module is configured to track said at least two objects by:
removing one or more features for points in the contours for said at least two objects having predicted coordinates that do not match coordinates of one or more points in the given image within a defined threshold.

18. The apparatus of claim 16 wherein the object tracking module is configured to track said at least two objects by:
adding one or more features characterizing convexity between points in the given image having coordinates that do not match predicted coordinates of points in the contours for said at least two objects within the defined threshold.

19. The apparatus of claim 16 wherein the object tracking module is configured to track said at least two objects by:
tracking said at least two objects in an additional image based at least in part on the updated calculated features.

20. The apparatus of claim 15 wherein the object tracking module is configured to extract contours of at least two objects in at least one of the images by:
applying contour regularization to the contours for said at least two objects.
